(19) United States
(12) Patent Application Publication
(10) Pub. No.: US 2011/0100901 A1
(43) Pub. Date: May 5, 2011

(54) IMPROVED FILTERING DRUM FOR FIBRE SUSPENSIONS IN WATER

(75) Inventor: Giancarlo Dal Maso, Schio (IT)

(73) Assignee: COMER S.P.A., San Vito Di Leguzzano (VI) (IT)

(21) Appl. No.: 12/993,388

(22) PCT Filed: May 21, 2009
(86) PCT No.: PCT/EP2009/003623

§ 371 Date: Nov. 18, 2010

(30) Foreign Application Priority Data
May 21, 2008 (IT) VI2008U000017

(51) Int. Cl. B01D 29/33

(52) U.S. Cl. 210/495

(57) ABSTRACT

The invention concerns a filtering drum (1) for fibre suspensions in water, comprising a plurality of shaped bars (2; 11, 13) with mainly longitudinal development, arranged side by side in order to define a tubular structure having substantially circular cross section, with the inner lateral surface (4) covered by a plurality of slits (3) that create a filtering surface, two or more annular elements (15) coaxial with one another and spaced according to the longitudinal axis (X) defined by the tubular structure, coupled through contact outside the shaped bars (2; 11, 13), wherein the shaped bars (2; 11, 13) are arranged according to a helical pattern.

The invention concerns an improved filtering drum that is used mainly in systems for filtering fibre suspensions in water, in particular for filtering cellulose fibres in a water suspension.

As is known, in the paper industry the suspensions of cellulose fibres in water, especially if they derive from waste paper, must be properly filtered in order to eliminate all the impurities they contain before being used in the production process.

The filtering process is carried out by means of the known strainers that substantially comprise a fixed filtering drum consisting of a plurality of metal bars with mainly longitudinal development, which are arranged circumferentially side by side in order to create a tubular structure that defines a longitudinal axis.

The bars have a shaped edge substantially in the shape of a trapezium and facing the inside of the drum, and are properly spaced from one another at equal distances.

In this way, the inner lateral surface of the drum is provided with a plurality of longitudinal slits, parallel to the longitudinal axis and having converging-diverging transverse profiles that define a corresponding number of ducts for the passage of the liquid to be filtered.

The inner lateral surface of the drum thus becomes the filtering surface.

Outside the bars there are annular elements coaxially spaced from one another, which lock them radially in such a way as to ensure that the drum has a constant tubular shape.

Inside the drum there is a rotor that sets the suspension to be filtered in movement, which, while passing through the longitudinal slits, releases the impurities contained therein on the inner lateral surface of the drum.

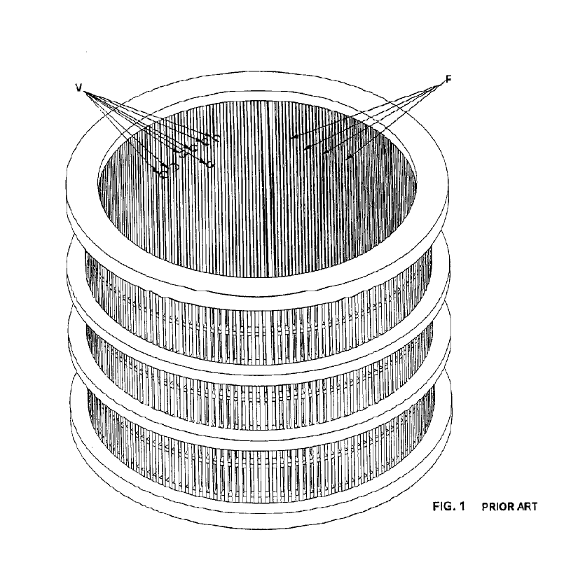

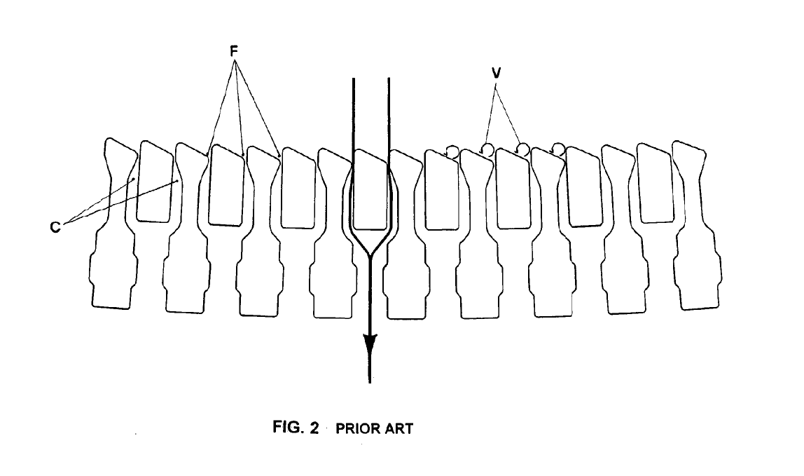

In fact, with reference to FIG. 1, which shows an axonometric view of a filtering drum constructed according to the known art, and to FIG. 2, which shows an enlarged part of a cross section of the same, when the rotor sets the suspension to be filtered rotating, vortices V are generated at the level of the slits F.

The suspension is filtered owing to the known Venturi effect while it passes through the above mentioned ducts C and is collected outside the drum.

During the filtering process, the impurities concentrate at the centre of the vortices V that form at the level of the slits and move spontaneously downward due to gravity, together with the suspension still to be filtered.

The filtering drums carried out according to the known art pose the drawback that their filtering action cannot exceed certain values that now represent limit values.

In fact, as shown in particular in FIG. 1, the direction of the speed transmitted by the impeller to the fluid to be filtered intersects the direction defined by the slits defining a right angle and the vortices that form, as already said, spontaneously move towards the bottom of the drum due to gravity.

Since said downward movement is rather slow, this limits the filtering speed and efficiency of the drums carried out according to the known art, whose values, as already explained, are now considered standard values that cannot be exceeded to a considerable extent.

The present invention intends to overcome the above mentioned drawback.

More particularly, the invention concerns a filtering drum for fibre suspensions in water, which makes it possible to filter larger quantities of suspension more rapidly compared to the drums belonging to the known art.

The object described above is achieved through the construction of a filtering drum having the characteristics described in the main claim, to which the reader should refer for the sake of brevity.

Further details of the invention are described in the dependent claims.

The filtering drum that is the subject of the invention is described here below with reference to the attached drawings, wherein:

FIG. 1 shows an axonometric view of a filtering drum belonging to the known art;

FIG. 2 shows an enlarged cross section of the filtering drum shown in FIG. 1, carried out orthogonally to its longitudinal axis;

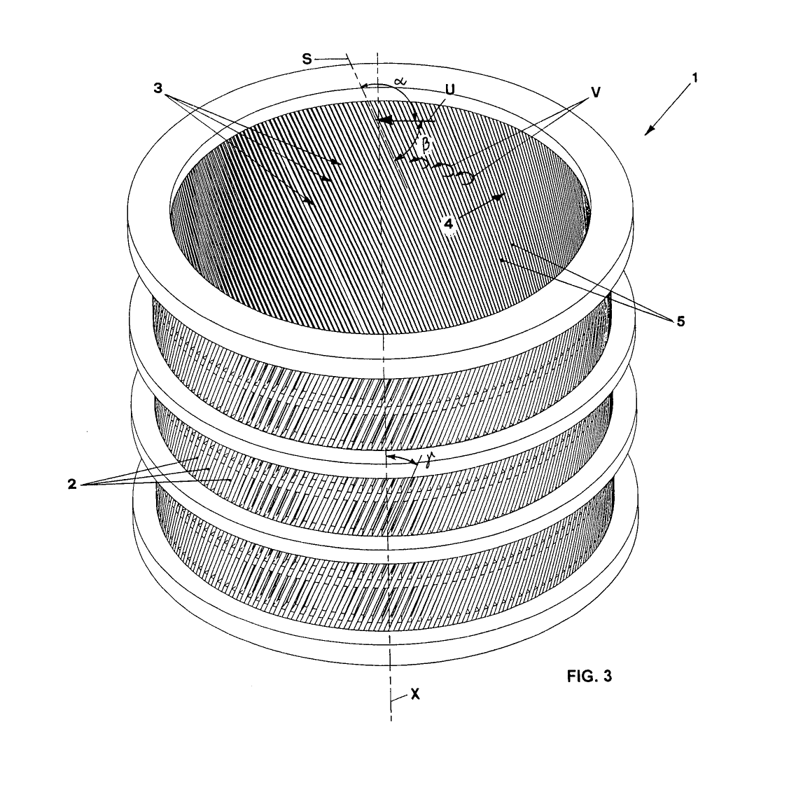

FIG. 3 shows an axonometric view of the drum that is the subject of the invention;

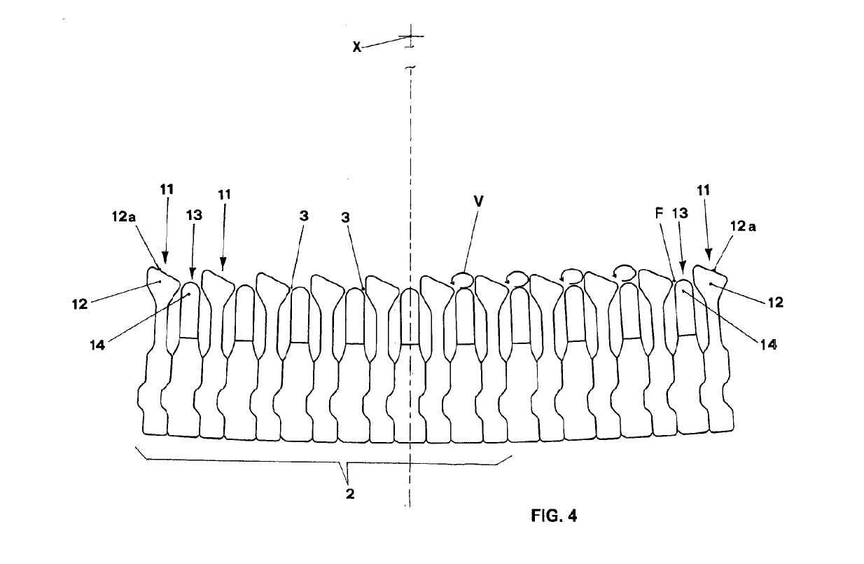

FIGS. 4 to 6 show different views of enlarged details of the drum shown in FIG. 3.

The filtering drum that is the subject of the invention is shown in axonometric view in FIG. 3, where it is indicated as a whole by 1.

It is used for filtering fibres in a water suspension and comprises a plurality of shaped bars 2 with mainly longitudinal development, arranged side by side, one against the other, in such a way as to form a plurality of slits 3.

In this way, the shaped bars 2 define a tubular structure with substantially circular cross section that defines a longitudinal axis X, whose inner surface 4 is the filtering surface.

The shaped bars have their edge 5 facing towards the inside of the drum II which is shaped according to profiles that have various geometries but in any way are such as to create slits 3 with converging-diverging cross sections that produce a Venturi effect on the fluid that flows radially through them.

According to the invention, the shaped bars 2 are arranged in a helical pattern. In this way, as shown in FIG. 3, the direction of the speed U that the rotor arranged inside the drum 1, not represented herein, transmits to the fluid, intersects the direction S defined by the shaped bars 2 forming two angles a and β that are supplementary angles different from right angles.

The vortices V formed in this way are thus subjected to a component of the speed U arranged along each shaped bar 2, which is added to the spontaneous movement speed of the fluid towards the bottom of the drum due to gravity.

The result is a movement speed of the vortices V towards the bottom of the drum 1 that is higher than the speed which can be obtained with drums of the known type and thus an increase in the filtering efficiency and effectiveness of the drum 1.

This allows the set object to be achieved, in fact larger quantities of suspension can be filtered more rapidly.

The inclination angle γ of the shaped bars 2 in relation to the longitudinal axis X may vary from 15° to 45° , making it possible to obtain optimal filtering results with inclination angles γ of 30°.

Furthermore, the shaped bars 2 can be arranged in a left-hand or right-hand winding direction in relation to the longitudinal direction defined by the longitudinal axis X.

Obviously, the drum can be constructed with shaped bars 2 of any type, for example of the type represented in the FIGS. 4 to 6, in which it is possible to observe that they comprise:

a plurality of main bars 11, each one provided with a shaped edge 12 with trapezium-shaped cross section, with the longer side 12a facing towards the inside of the drum 1 formed by them;

a plurality of secondary bars 13, each one provided with a shaped edge 14 with curved cross section, with convexity facing towards the inside of the drum.

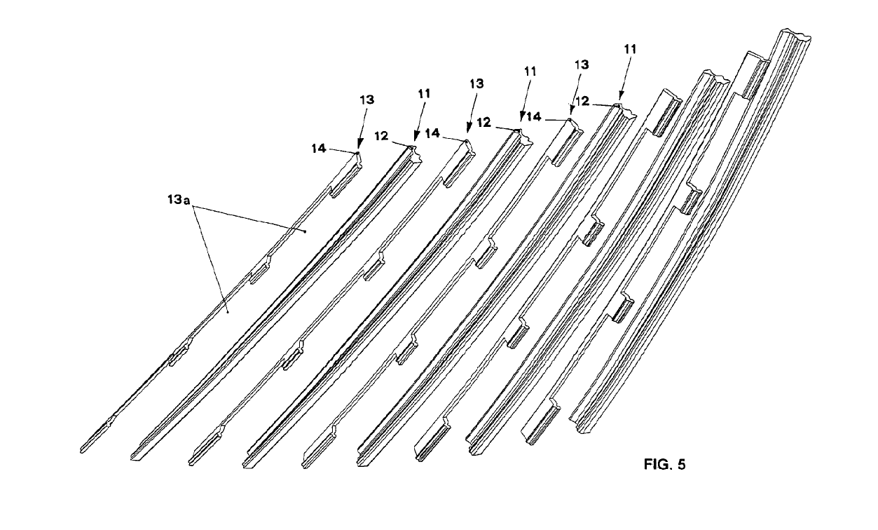

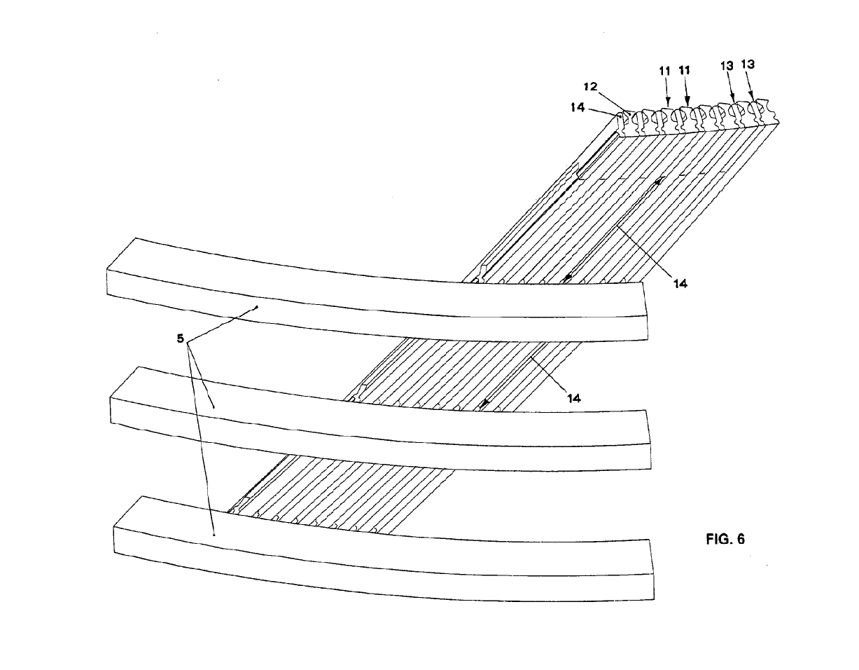

FIGS. 5 and 6 show that each main bar 11 is included between two secondary bars 13 and each one of the main bars 11 has constant cross section in the direction defined by its length.

Beside it there is a secondary bar 13 with variable cross section in the direction defined by its length, as it features C-shaped empty areas 13a.

In this way, between the bars 11 and 13 of the drum 1 drainage chambers 14 are defined which further improve the filtering quality of the fibre suspension, in addition to the improvement offered by the helical arrangement of the shaped bars 2.

The empty areas 13a of the secondary bars 13 are created in such positions that the drainage chambers 14 are included between the annular elements 15 that externally surround the bars 11 and 13 coming into contact with them.

On the basis of the above, it is clear that the drum that is the subject of the invention achieves all the set objects.

In the construction stage, the drum of the invention may be subjected to changes that are neither described herein nor shown in the drawings.

Said changes, however, must all be considered protected by the present patent, provided that they fall within the scope of the claims expressed below.

1-9. (canceled)

10. A filtering drum for filtering fibre suspensions in water, comprising:
a plurality of shaped bars with mainly longitudinal development, arranged side by side in order to define a tubular structure having a substantially circular cross section, with an inner lateral surface covered by a plurality of slits that create a filtering surface;
two or more annular elements coaxial with one another and spaced according to a longitudinal axis defined by said tubular structure, coupled through contact outside said shaped bars,
said shaped bars being arranged according to a helical pattern wherein said shaped bars comprise a plurality of main bars each one provided with a shaped edge with a trapezium-shaped cross section having the longer side facing towards the inside of said drum and a plurality of secondary bars each one provided with a shaped edge having a curved cross section with convexity facing towards the inside of said drum.

11. A filtering drum according to claim 10, wherein said shaped bars have a left-hand winding direction along the longitudinal direction defined by said longitudinal axis.

12. A filtering drum according to claim 10, wherein said shaped bars have a right-hand winding direction along the longitudinal direction defined by said longitudinal axis.

13. A filtering drum according to claim 10, wherein each one of said shaped bars forms an angle ranging between 15° and 45° in relation to said longitudinal axis.

14. A filtering drum according to claim 13, wherein each one of said shaped bars forms an angle of 30° in relation to said longitudinal axis.

15. A filtering drum according to claim 10, wherein each one of said main bars is included between two of said secondary bars.

16. A filtering drum according to claim 10, wherein between each pair of said main bars there is one of said secondary bars.

17. A filtering drum as in any of claims 10-16, wherein each one of said main bars has a constant cross section lengthwise and each one of said secondary bars has a variable cross section lengthwise, each one of said secondary bars featuring empty areas realized as recesses delimited by bar portions with C-shaped longitudinal sections.

18. A filtering drum according to claim 17, wherein said empty areas are provided in the areas of said drum included between said annular elements.
